(19) United States
(12) Patent Application Publication
(10) Pub. No.: US 2016/0153229 A1
(43) Pub. Date: Jun. 2, 2016

(54) Sequential control roller system for variable a pitch shutter

(71) Applicant: Hangzhou Wokasolar Technology Co., Ltd., Hangzhou (CN)

(72) Inventors: YIFEI ZHANG, HANGZHOU (CN); HUIWEN XU, HANGZHOU (CN)

(73) Assignee: HANGZHOU WOKASOLAR TECHNOLOGY CO., LTD., Hangzhou (CN)

(21) Appl. No.: 14/556,210

(22) Filed: Nov. 30, 2014

(30) Foreign Application Priority Data
Nov. 27, 2014 (CN) 2014107052488

(51) Int. Cl. E06B 9/32

(52) U.S. Cl. CPC E06B 9/32

(57) ABSTRACT

The present invention discloses a sequential control roller system for a variable pitch shutter. The system comprises a lifting device for controlling the overall lifting and switchover of all blades and a blade separating/shutting and turnover device for controlling the lifting of the blades relative to each other and the overall turnover of the blades. The lifting device is in transmission connection to the blade separating/shutting and turnover device. The lifting device comprises: a planetary gear clutch capable of controlling the retraction and extension of a lifting rope for realizing the overall fitting of all blades and capable of providing power to the blade separating/shutting and turnover device; and a switching slider mechanism for switching the working state of the planetary gear clutch. The blade separating/shutting and turnover device comprises a number of blade turnover drums and blade translation control rollers. Ladder belts for controlling the separate lifting and turnover of the blades are wound on the corresponding blade turnover drums and fixed on the corresponding blade translation control rollers.

### CROSS REFERENCE TO RELATED PATENT APPLICATION

The present application is a continuation in part application of U.S. Ser. No. 13/695,074 filed on Oct. 29, 2012, which is a US national stage of PCT/CN2011/073552 filed on Apr. 29, 2011 claiming a priority right of CN 201010162501.1 filed on Apr. 30, 2010. This application also claims the priority of CN 2014107052488 filed on Nov. 27, 2014.

### TECHNICAL FIELD OF THE INVENTION

The present invention relates to a shutter control system, and more particularly to a sequential control roller system for a variable pitch shutter having built-in hollow glass.

### BACKGROUND OF THE INVENTION

A hollow glass window consists of a top frame, a bottom frame, two side frames and two pieces of glass inlaid therein. A conventional shutter with built-in hollow glass consists of blades mounted between the two pieces of glass, a lifting rope, ladder belts, a bottom rail and a number of rollers used for winding the lifting rope and installed between the top frame and the side frames. The upper end of the lifting rope is connected to the rollers installed within the top frame, while the lower end thereof is connected to the bottom rail. Two upper ends of the ladder belts are butted and sheathed on the rollers installed within the top frame, while the lower ends thereof are fixedly connected to the bottom rail. A plurality of parallel blades passes through breast ropes of the ladder belts. Through holes are provided at the centers of symmetry of the cross sections of the blades so as to allow the lifting rope to pass therethrough. By driving the rollers to rotate, the blades may be raised (folded) and lowered (unfolded) and turned over. When the blades are folded, the lifting rope is wound to drive the bottom rail to raise, so as to lift up and fold the blades in turn. When the blades are put down, the lifting rope is released, and the blades are moved down in turn under the gravity of the bottom rail and then placed equidistantly after spaced apart by the breast ropes of the ladder belts. When the bottom rail reaches a sill, the lifting rope is released over. When a rotation driver continues to be pulled, the rollers turn over the blades under the action of friction so as to achieve the effect of indoor dimming.

One critical defect of the conventional shutter is that indoor daylight illumination cannot be uniform. If the blades are turned over until the illumination near a window is moderate and free from glare, the luminance of indoor longitudinal depth is insufficient and it is necessary to perform artificial illumination. If the blades are turned over until the luminance of indoor longitudinal depth is just enough, there will be glares near to the window. In addition, in summer, people needs moderate brightness but not heat; while in winter, people needs moderate brightness and heat. However, for a conventional shutter, to reduce the brightness and hear near to a window, the blades of the shutter have to be turned over to an approximately closed degree whether in summer or in winter. Consequently, the whole room is too dark, so that the appropriate degree of indoor illumination needs to be kept by artificial illumination whether on a sunny day or on a cloudy day. Thus, lots of energy sources will be wasted, and the comfort and work efficiency of people are also reduced. Therefore, to avoid glares and superheat near to a window and to be able to achieve uniform daylight illumination in indoor depth, Chinese Invention Patent No. ZL201010162501.1 has disclosed a toothed prism blade capable of changing pitch of the blade. A shutter formed from such variable pitch toothed prism blades will not change the path of light irradiated onto the blades no matter whether the solar altitude angle H is greater than or less than the angle of blade sunshade, so that the requirements of avoiding glares and superheat may be met, and the requirements of achieving uniform daylight illumination in indoor depth may also be met, without influencing visual communication and air motion between indoor and outdoor. However, this invention patent application has disclosed a composite structure of blades and the sunshade and light guide effects of the overall lifting, relative lifting and turnover of the blades, but has not disclosed any transmission mechanism related to the shutter. Subsequently, Chinese invention patents ZL201010162501.1, ZL201210271697.7, ZL201210266070.2, ZL201210266095.2, ZL201210269650.7, ZL201210268529.2 and ZL201210271768.3 have discloses sequential control roller systems and slider systems applicable to transmission mechanisms of the above variable pitch shutter (inner curtain and outer curtain), but have not disclosed sequential control roller systems for the variable pitch shutter having built-in hollow glass.

### SUMMARY OF THE INVENTION

A transmission control system of the above variable pitch shutter is mostly disposed on the top of the shutter. The transmission control system disposed on the top of the variable pitch shutter is not suitable for installation in the hollow glass. To overcome this defect, the present invention provide a sequential control roller system for a variable pitch shutter having built-in hollow glass, which makes full use of the structural features of the variable pitch shutter having built-in hollow glass to arrange the transmission control system of the variable pitch shutter inside the hollow glass.

The technical solutions of the present invention are as follows: a sequential control roller system for a variable pitch shutter having built-in hollow glass is provided, wherein the system includes a lifting device for controlling overall lifting and switchover of all blades and a blade separating/shutting and turnover device for controlling the lifting of the blades relative to each other and the overall turnover of the blades, the lifting device being in transmission connection to the blade separating/shutting and turnover device; the lifting device includes a planetary gear clutch capable of controlling the retraction and extension of a lifting rope for realizing the overall fitting of all blades and capable of providing power to the blade separating/shutting and turnover device, and a switching slider mechanism for switching the working state of the planetary gear clutch; the blade separating/shutting and turnover device includes a number of blade turnover drums and blade translation control rollers; and, ladder belts for controlling the separate lifting and turnover of the blades are wound on the corresponding blade turnover drums and fixed on the corresponding blade translation control rollers. The planetary gear clutch runs after receiving externally input torque. The planetary gear clutch may be switched between two following working modes in a certain timing sequence: retracting and extending the lifting rope, and providing power to the blade separating/shutting and turnover device. When in the former mode, the planetary gear clutch only retracts or extends the lifting rope to control the variable pitch shutter to be folded or unfolded as a whole. When the variable pitch shutter is unfolded as a whole, a number of blades form a group and are fitted with each other in the groups, and the space between groups is variable. During this process, the separating/shutting and turnover device is in a halted state due to no power. After the variable pitch shutter is unfolded as a whole, the planetary gear clutch is switched to the mode of outputting powder to the separating/shutting and turnover device by the switching slider mechanism and other state switchover activation mechanisms. Hereafter, the planetary gear clutch begins to perform expansion, turnover and other operations of blades in each group in the case of continuously receiving externally input torque.

Preferably, the lifting device further includes a power output locking gear and an overall lifting locking gear, which are in transmission connection to the planetary gear clutch via tooth engagement mechanisms, respectively, and the power output locking gear is in transmission connection to the blade separating/shutting and turnover device via a tooth engagement mechanism. The power output locking gear and the overall lifting locking gear lock the corresponding functions of the planetary gear clutch at different times, respectively, so as to generate the working sequence of the planetary gear clutch.

Preferably, the planetary gear clutch includes a sun gear, a set of planetary gears, a lifting rope roller, a locking ratchet wheel and a planetary gear carrier with an external gear, the lifting rope roller, the locking ratchet wheel and the planetary gear carrier being coaxially parallel in turn and the lifting rope roller and the locking ratchet wheel being fixedly connected to each other, an annular groove for winding the lifting rope being provided on the lifting rope roller, a ratchet being provided at the upper part of the locking ratchet wheel, inner teeth located on an end face facing the planetary gear carrier being also provided on the locking ratchet wheel, the centers of the lifting rope roller, the locking ratchet wheel and the planetary gear carrier being all rotatably sheathed on a gear shaft of the sun gear, the planetary gears being rotatably connected onto an end face of the planetary gear carrier opposing to the locking ratchet wheel and surrounding the sun gear, the planetary gears being also engaged with the sun gear and the inner teeth. The planetary gear clutch having the above structural features has dual functions of retracting and extending the listing rope and outputting torque via the planetary gear carrier. The planetary gear set ensures that the locking ratchet wheel and the planetary gear carrier are not restricted to each other, and the kinetic energy released by the other one may be input after the rotation of any one of the locking ratchet wheel and the planetary gear carrier is hindered.

Preferably, the switching slider mechanism includes two guide seats, two guide rods, a first slider and a second slider, the guide seats being fixed on a side frame of the hollow glass shutter, the two guide rods being fixedly connected onto the first slider and the second slider, respectively, the guide seats being in sliding connection to the two guide rods, respectively, compression springs being provided between the first slider and second slider and the corresponding guide seats, a power output locking portion capable of coordinating with the first slider being provided on the power output locking gear, an overall lifting locking portion capable of coordinating with the ratchet being provided on the second slider, an axial boss being provided in the center of the power output locking gear, the power output locking portion being a notch disposed on the boss and fitted with an end portion of first slider, the overall lifting locking portion being a lateral step. When the power output locking portion of the power output locking gear is fitted with the first slider, the power output locking gear is locked, and the function of outputting power outward of the planetary gear clutch is shielded at this time. When the second slider is fitted with the ratchet via the overall lifting locking portion, the function of retracting and extending the listing rope of the planetary gear clutch is shielded.

Preferably, a sectored groove is provided within the annular rope-winding groove of the lifting rope roller in the radial direction; on a sectored wall of the sectored groove, hinged is a Tr-shaped crank limiting rod capable of being turned-over to be hidden within the sectored groove and exposed from the sectored groove and capable of resisting against an end portion of the first slider; and, a protruded driving pin shaft is provided between the center and edge of the overall lifting locking gear, the driving pin shaft resisting against an end portion of the second slider. The crank limiting rod may activate the conversion of the working mode of the planetary gear clutch. When the lifting rope is released over, the listing rope rollers will not roll the lifting rope any more, and the crank limiting rod may turn outward depending on its gravity after losing the restriction of the lifting rope, then resists against and pushes the first slider by means of the support of the wall of the sectored groove and gradually unlocks the power output locking gear. Meanwhile, the compression of the driving pin shaft to the second slider is gradually reduced, the second slider gradually moves to a position fitted with the ratchet under the action of the compression spring, and the conversion from the mode of winding the lifting rope to the mode of outputting power of the planetary gear clutch is finally accomplished. Reverse operations may realize the conversion from the mode of outputting powder to the mode of winding the lifting rope.

Preferably, the blade separating/shutting and turnover device includes a torsion spring locking mechanism, a turnover drum locking mechanism, a first roller mechanism, a second roller locking mechanism and a second roller mechanism, which are arranged from down to up in turn and in transmission connection to each other; each of the blade turnover drums includes a first turnover drum disposed in the first roller mechanism and a second turnover drum disposed in the second roller mechanism; each of the blade translation control rollers includes a first roller disposed in the first roller mechanism and a second roller disposed in the second roller mechanism; the torsion spring locking mechanism includes a power input gear and a mating gear, which are coaxial to each other, with an arc wall and a complementary arc wall being provided on an end face of the power input gear opposing to the mating gear, respectively; and, a torsion spring is sheathed on shafts of the power input gear and the mating gear, and two ends of the torsion spring are disposed in clearances between corresponding ends of the arc wall and the complementary arc wall, respectively. The power input gear imports powder from the lifting device, and then transfers the power to the turnover drum locking mechanism, the first roller mechanism, the second roller locking mechanism and the second roller mechanism via the torsion spring and the mating gear. When there is no external powder in the power input gear, the torsion spring locking mechanism locks the blade separating/shutting and turnover device, so that the blades may stay at any position but not move down due to gravity.

Preferably, the turnover drum locking mechanism includes a first cam driving gear, a first cam, a turnover drum control gear and a fixed block fixed on a side wall of the shutter, which are all coaxial to each other, the first cam driving gear, the first cam and the turnover drum control gear being in transmission connection to each other, the first cam driving gear and the turnover drum control gear being engaged with the power input gear and the mating gear, respectively; a raised arc section is provided on the first cam; and, the turnover drum control gear is an incomplete gear with teeth provided on a part of the periphery and a smooth arc on the other part of the periphery, a limiting arc wall and a limiting boss which can be fitted with each other being provided on opposite faces of the turnover drum control gear and the fixed block, respectively. The motions of the blade turnover drums and the blade translation control rollers are relatively independent, and are directly powered by the turnover drum control gear and the first cam driving gear, respectively. The first cam driving gear, the first cam and the turnover drum control gear are synchronous all the time. As the turnover drum control gear is an incomplete gear, the blade turnover drums and the blade translation control rollers may work in a certain sequence, and the translation of the blades in groups and the turnover of the blades are accomplished within a certain time.

Preferably, the first roller mechanism includes a roller driving gear, a second cam, a turnover drum driving gear, a first turnover drum and a first roller, which are all arranged coaxially in turn, the roller driving gear being engaged with the first cam driving gear, the turnover drum driving gear being engaged with the turnover drum control gear, the roller driving gear being in transmission connection to the first roller, the second cam being in transmission connection to the first turnover drum, an arc notch fitted with the raised arc section being provided on the second cam, a first ladder belt and a second ladder belt being wound across the first turnover drum, a fixed point of the first ladder belt being fastened onto the first turnover drum, the second ladder belt being wound onto the first roller after going through the bottom of the first turnover drum, a fixed point of the second ladder belt being fastened onto the first roller. This structure may ensure that the first turnover drum is maintained at a stable state when the primary blades and secondary blades in each group of blades perform translation under the drive of the first ladder belt and the second ladder belt, respectively, so that the translation of blades and the turnover of blades are accomplished in steps without mutual interferences.

Preferably, the second roller locking mechanism includes a third cam driving gear, a third cam and a second turnover drum control gear, which are all coaxially arranged in turn, the third cam driving gear being an incomplete gear with teeth provided on a part of the periphery and a smooth arc on the other part of the periphery, the third cam driving gear being engaged with the roller driving gear and being in transmission connection to the third cam, a raised locking arc being provided on the third cam, the second turnover drum control gear being engaged with the turnover drum driving gear. In the case of having more blades in each group, the structure may ensure that the blades controlled by the second roller and the blades controlled by the first roller perform translation in a certain sequence, respectively.

Preferably, the second roller mechanism includes a second-stage roller driving gear, a fourth cam, a second turnover drum driving gear, a second turnover drum and a second roller, which are coaxially arranged in turn, the second-stage roller driving gear being engaged with the third cam driving gear, the second turnover drum driving gear being engaged with the second turnover drum control gear, the second-stage roller driving gear, the fourth cam and the second roller being in transmission connection to each other, the second turnover drum driving gear being in transmission connection to the second turnover drum, a locking notch fitted with the raised locking arc being provided on the fourth cam, a third ladder belt being wound across the second turnover drum, the third ladder belt being wound onto the second roller after going through the bottom of the second turnover drum, a fixed point of the third ladder belt being fastened onto the second roller. If there are three blades in each group, the structure may ensure that the secondary blades in each group of blades perform translation and turnover in a certain sequence.

The present invention has the following advantages:

the present invention overcomes the defect in the prior art that the transmission control mechanism for a variable pitch shutter is not suitable for a variable pitch shutter having built-in hollow glass, and provides a sequential control roller system for a variable pitch shutter having built-in hollow glass, which makes full use of the structural features of the variable pitch shutter having built-in hollow glass to install the transmission control system of the variable pitch shutter inside the hollow glass.

### BRIEF DESCRIPTION OF THE DRAWINGS

FIG. 1 is a three-dimensional and partial section view of a variable pitch shutter having built-in hollow glass, with lifting blades;

FIG. 2 is a motion state diagram of a unit of a variable pitch shutter with one relative lifting blade;

FIG. 3 is a motion state diagram of a unit of a variable pitch shutter with two relative lifting blades;

FIG. 4 is a three-dimensional diagram of a sequential control roller system for a variable pitch shutter having built-in hollow glass;

FIG. 5 is a three-dimensional diagram of connection relations between a lifting rope and each ladder belt and a steering device;

FIG. 6 is a three-dimensional diagram of a lifting device for controlling the overall lifting and switching of blades;

FIG. 7 is a three-dimensional diagram of a roller device for controlling the relative lifting and turnover of blades;

FIG. 8 is a partially three-dimensional and exploded left view of a lifting device for controlling the overall lifting and switching of blades;

FIG. 9 is a partially three-dimensional and exploded right view of a lifting device for controlling the overall lifting and switching of blades;

FIG. 10 is a three-dimensional exploded view of a switching slider mechanism of a lifting device for controlling the overall lifting and switching of blades;

FIG. 11 is another three-dimensional exploded view of a switching slider mechanism of a lifting device for controlling the overall lifting and switching of blades;

FIG. 12 is a three-dimensional diagram of the connection relation between a roller structure of a lifting device for controlling the overall lifting and switching of blades and a lifting rope;

FIG. 13 is a diagram showing a first motion state of a lifting device for controlling the overall lifting and switching of blades;

FIG. 14 is a diagram showing a second motion state of a lifting device for controlling the overall lifting and switching of blades;

FIG. 15 is a diagram showing a third motion state of a lifting device for controlling the overall lifting and switching of blades;

FIG. 16 is a three-dimensional diagram of the connection relation between each ladder belt and rollers and turnover drums;

FIG. 17 is a right axonometric exploded view of a roller device for controlling the relative lifting and turnover of blades;

FIG. 18 is a left axonometric exploded view of a roller device for controlling the relative lifting and turnover of blades corresponding to the state of each part in FIG. 3a after the blades are lowered as a whole;

FIG. 19 is a left axonometric exploded view of a roller device for controlling the relative lifting and turnover of blades corresponding to the state of each part in FIG. 3b after blades 2 and 3 are relatively lowered to preset positions;

FIG. 20 is a left axonometric exploded view of a roller device for controlling the relative lifting and turnover of blades corresponding to the state of each part in FIG. 3c after blade 3 is relatively lowered to a preset position; and

FIG. 21 is a left axonometric exploded view of a roller device for controlling the relative lifting and turnover of blades corresponding to the state of each part in FIG. 3d after all are turned over.

### DETAILED DESCRIPTION OF THE INVENTION

The present invention will be further described as below with reference to the accompanying drawings by specific embodiments. The pitch used in the present invention refers to a distance between two adjacent primary blades.

### Embodiment 1

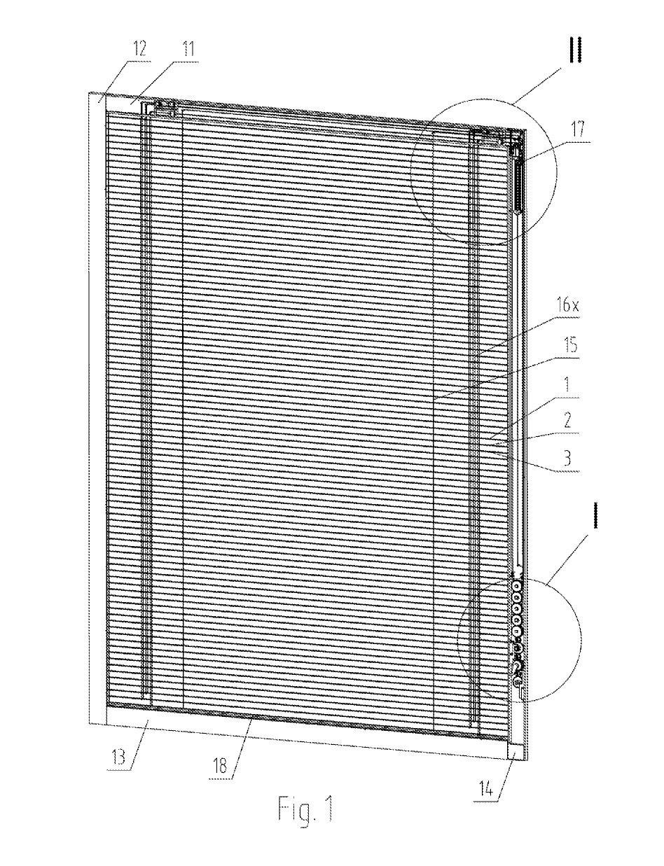

FIG. 1 shows variable pitch shutter having built-in hollow glass with a plurality groups of blades (from indoor to outdoor), where there are three blades in each group. The variable pitch shutter consist of a top frame 11, a bottom frame 13, a left side frame 12, a right side frame 14, a sequential control roller system 8, a rope guiding and connecting device 17, a lifting rope 15, a first ladder belt 161, a second ladder belt 162, a third ladder belt 163, a primary blade 1, lifting blades and a bottom rail 18. The lifting blades include a first secondary blade 2 and a second secondary blade 3. The first ladder belt 161, the second ladder belt 162 and the third ladder belt 163 are connected to the primary blade 1, the first secondary blade 2 and the second secondary blade 3. The primary blade 1, the first secondary blade 2 and the second secondary blade 3 form one group of blades.

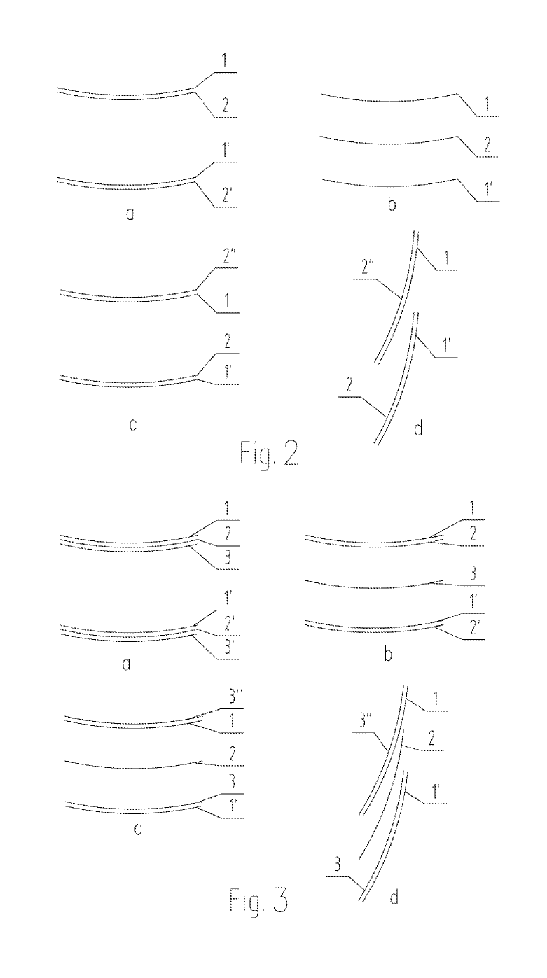

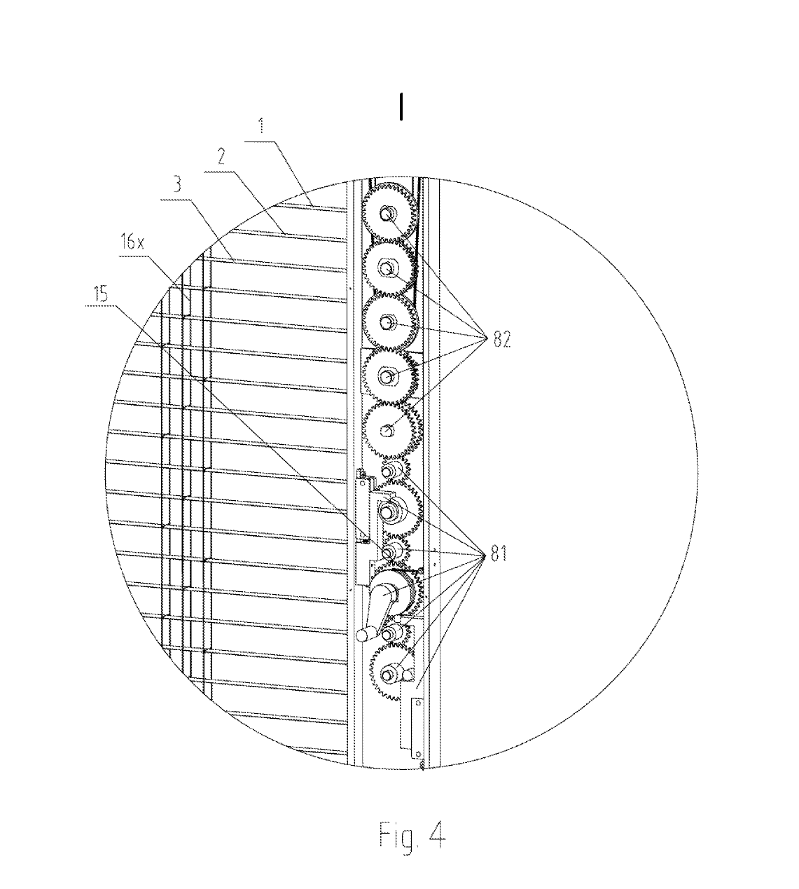

To the sequential control roller system 8 more clearly, the numerals of the primary blade 1 and lifting blades 2, 3 in one unit of the shutter disclosed by Chinese Invention Patent No. ZL201010162501.1 are modified and renamed as two adjacent primary blades 1, 1″ and listing blades 2, 3′ and 2″, 3″, and the motion state diagram of a unit of a variable pitch shutter with one lifting blade 2 (as shown in FIG. 2) and the motion state diagram of a unit of a variable pitch shutter with two lifting blade 2, 3 (as shown in FIG. 3) are redrawn.

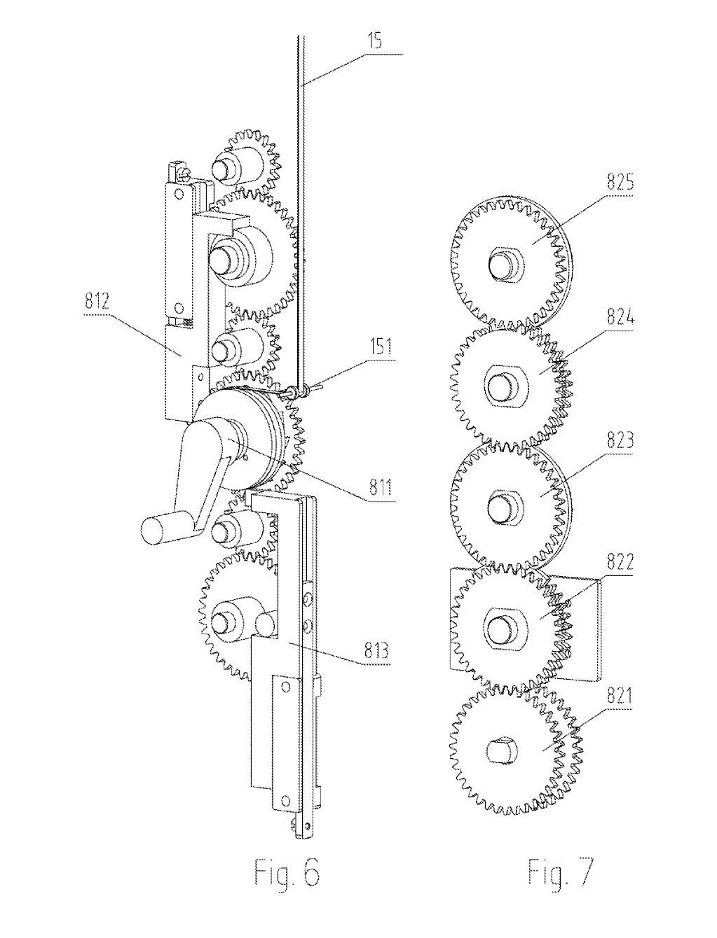

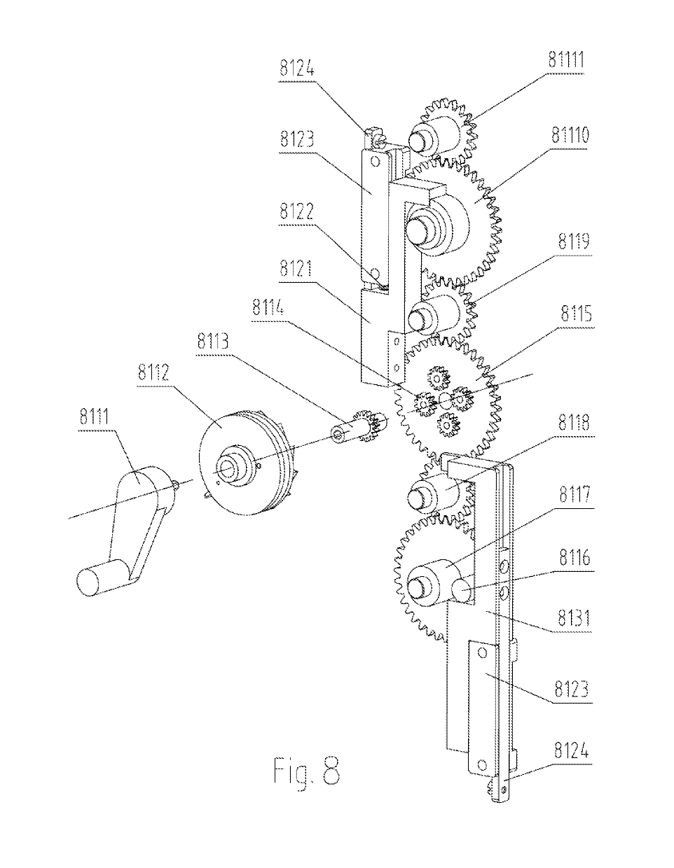

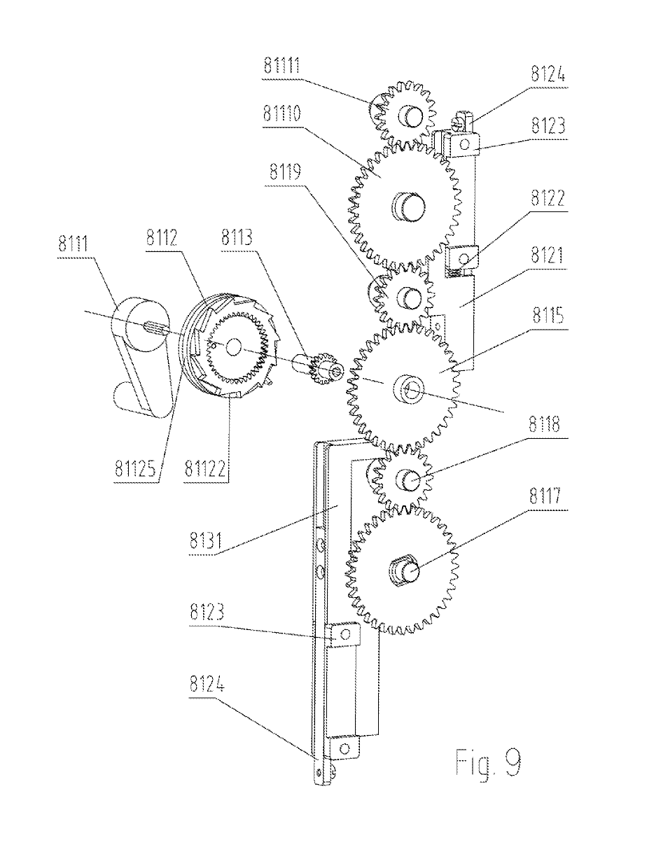

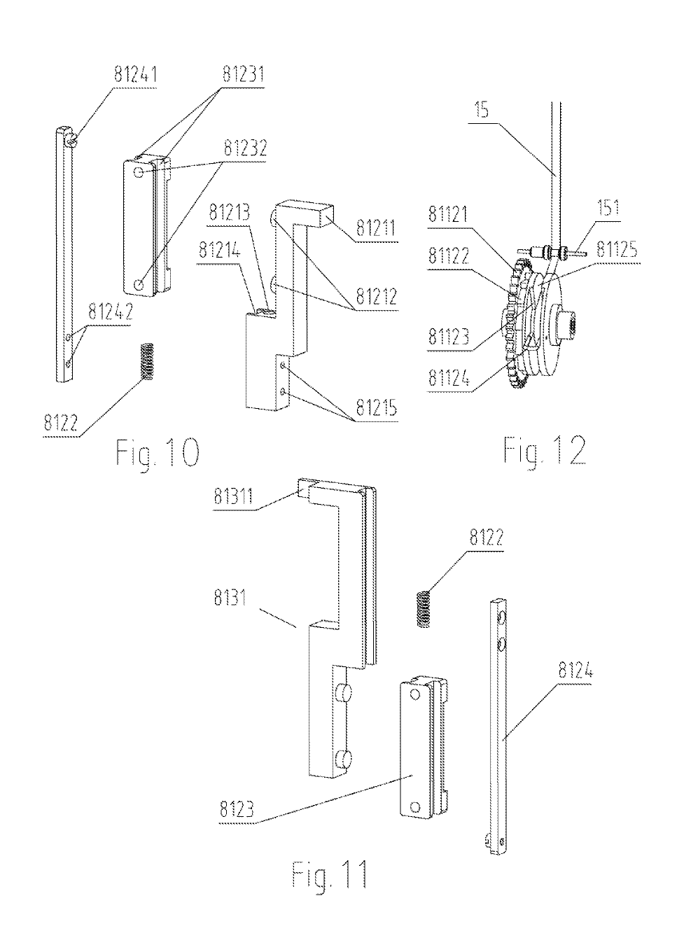

FIG. 4 shows a partially three-dimensional enlarged view of a sequential control roller system 8 for a variable pitch shutter having built-in hollow glass. The sequential control roller system consists of a lifting device 81 for controlling the overall lifting and switching of blades and a device 82 for controlling the relative lifting of the first secondary blade 2 and the second secondary blade 3 and the turnover of blades. FIG. 6 shows the connection relation of the structure of the lifting device 81 for controlling the overall lifting and switching of blades and a lifting rope 15. FIG. 8 is a partially three-dimensional and exploded left view of the lifting device for controlling the overall lifting and switching of blades of the sequential control roller system 8 for a variable pitch shutter having built-in hollow glass. FIG. 9 is a partially three-dimensional and exploded right view of the lifting device 81 for controlling the overall lifting and switching of blades of the sequential control roller system 8 for a variable pitch shutter having built-in hollow glass. FIG. 10 is a three-dimensional exploded view of a switching slider mechanism of the blade separating/shutting and turnover device 82 of the sequential control roller system for a variable pitch shutter having built-in hollow glass. FIG. 11 is another three-dimensional exploded view of the switching slider mechanism of the lifting device 81 for controlling the overall lifting and switching of blades of the sequential control roller system for a variable pitch shutter having built-in hollow glass. FIG. 12 is a three-dimensional diagram of the connection relation between a roller structure of the lifting device 81 for controlling the overall lifting and switching of blades and the lifting rope 15 of the sequential control roller system for a variable pitch shutter having built-in hollow glass. The lifting device 81 for controlling the overall lifting and switching of blades consists of a planetary gear and transmission gear set 811, a first slider mechanism 812 for controlling the overall lifting and relative lifting actions for switching via a planetary gear carrier 8115, and a second slider mechanism 813 for controlling the overall lifting of blades via a locking ratchet wheel 8112. The planetary gear and transmission gear set 811 consists of a handle 8111, a planetary gear clutch, an overall lifting locking gear 8117, a driving pin shaft 8116, a power output locking gear 81110, a first transmission gear 8118, a second transmission gear 8119 and a third transmission gear 81111. The planetary gear clutch consists of a lifting rope roller, a locking ratchet wheel 8112, a sun gear 8113, planetary gears 8114 and a planetary gear carrier 8115, which are coaxially arranged. The switching slider mechanism is divided into a first slide mechanism 812 and a second slider mechanism 813, totally including two guide seats 8123, two guide rods 8124, a first slider 8121 and a second slider 8131. The two guide seats 8124 are slidingly connected to the two guide rods 8124, respectively. Compression springs 8122 are provided between the first slider 8121 and second slider 8131 and the corresponding guide seats 8123, respectively. The locking ratchet wheel 8112 is provided thereon with an annular rope-winding groove 81126 for winding the lifting rope 15 and a one-way ratchet 81122. Sectored grooves are formed on two inner walls of the annular rope-winding groove, and a pin shaft is provided on the sectored wall to fix the upper end of the lifting rope 15. Meanwhile, a pin hole is formed for hinging a Tr-shaped crank limiting rod 81125, so as to allow the crank limiting rod to freely rotate in the sectored groove 81126 (referring to FIG. 12). A hexagonal shaft on the handle 8111 is inserted into the sun gear 8113, so that the planetary gear and transmission gear set 811 is manually driven to rotate. The planetary gear carrier 8115 is engaged with the first transmission gear 8118 and the second transmission gear 8119. The first transmission gear 8118 and the second transmission gear 8119 are engaged with the overall lifting locking gear 8117 and the power output locking gear 81110, respectively. The first slider mechanism 812 consists of a first slider 8121, a guide seat 8123 and a guide rail 8124. The first slider 8121 is a zigzag block with a guide pin 81212, a round hole 81213 for mounting the compression spring 8122, a chute 81214 and two screw holes 81215 thereon. Chutes 81231 and two through holes 81232 are provided on two sides of each of the guide seat 8123. A positioning screw 81241 is provided at one end of each of the guide rods 8124, while two through holes 81242 are provided on the other end thereof. The structure of the second slider is roughly similar to that of the first slider mechanism 812, with a unique difference that a part of the head 81311 of the second slider 8131 is cut off. The guide rods 8124 are installed in the chute 81214 of the first slider 8121, and then the both are fixed together via screws after passing through the through holes 81215 on the first slider 8121 and the through holes 81242 of the guide rods 8124. Then, the compression springs 8122 are placed into the round hole 81213 of the first slider 8121. Finally, the guide rod 8124 and the guide pin 81212 on the first slider 8121 are embedded into the chutes 81241 on two sides of the guide seat 8123, and then fixed on the right side frame 14 by screws after passing through the two screw holes 81232 of the guide seat 8123. The assembly of the second slider mechanism 813 is similar to that of the first slider mechanism 812.

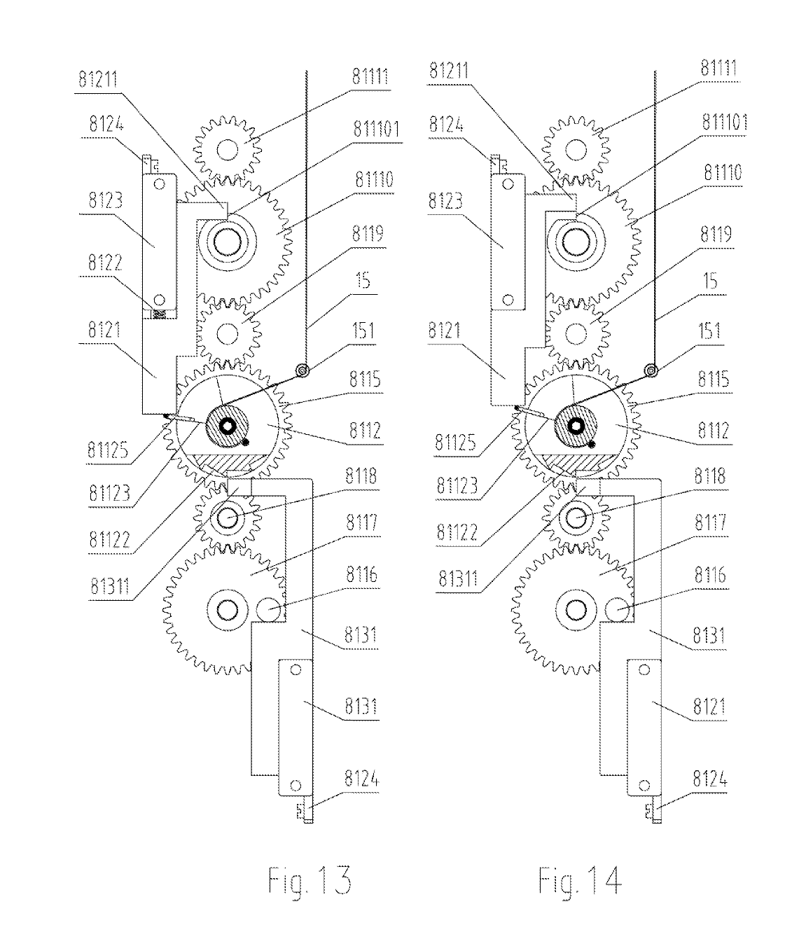

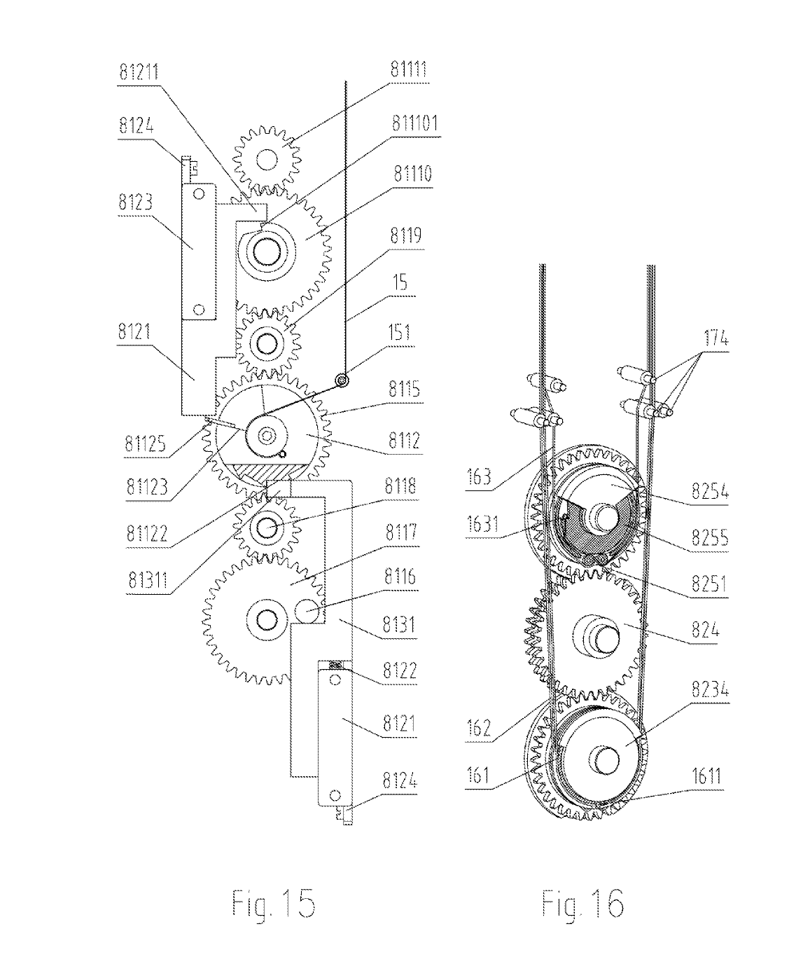

FIG. 13 is a diagram showing a first motion state of the lifting device 8 for controlling the overall lifting and switching of blades of the sequential control roller system for a variable pitch shutter having built-in hollow glass, i.e., the motion process from the folded state to the fully unfolded state of the blades of the variable pitch shutter (referring to FIG. 3a). During the motion process of the blades, the sun gear 8113 is driven to rotate by shaking the handle 811. At this time, the head of the first slider 8121 of the first slider mechanism 812 is embedded into notch 811101 on the power output locking gear so as to lock the power output locking gear 81110, and the planetary gear carrier 8115 is also locked by the engagement of the second transmission gear 8119 with the power output locking gear 81110. In this case, the heat 81311 of the second slider 8131 of the second slider mechanism 813 is separated from the ratchet 81122 on the locking ratchet wheel 8112. The locking ratchet wheel 8112 may be rotated clockwise. The lifting rope 15 in the annular rope-winding groove 81126 on the locking ratchet wheel 8112 is gradually released with the rotation of an inner tooth gear. When the lifting rope 15 is fully released, the crank limiting rod 81125 is free from the restriction of the lifting rope 15 and then counterclockwise rotates around its spindle from the bottom of the annular rope-winding groove 81126 of the locking ratchet wheel 8112 to the sectored wall 81123 of the sectored groove of the annular rope-winding groove 81126 of the locking ratchet wheel 8112, so that the first slider 8121 is pushed to slide upward by the crank limiting rod 81125 thus to unlock the planetary gear wheel 8115. After the overall descent of the blades, the relative lifting motion of first secondary blades 2, 3 is started. At this time, the instantaneous state of the sequential control roller system 8 is as shown in FIG. 14. The handle 8111 continues to be shaken, and the guide seat 8123 of the first slider mechanism 812 prevents the first slider 8121 from sliding upward so as to prevent the locking ratchet wheel 8112 from rotating clockwise. The planetary gear carrier 8115 is rotated counterclockwise after unlocked, so that the overall lifting locking gear 8117 and the power output locking gear 81110 are driven to rotate counterclockwise by the first transmission gear 8119 and the first transmission gear 8118, respectively. The pin shaft 8116 of the overall lifting locking gear 8117 withdraws the pushing force to the second slider 8131 of the second slider mechanism 813. Under the action of the compression springs 8122, the second slider 8131 slides upward, and head 81311 of the second slider is gradually embedded into the ratchet 81122 on the locking ratchet wheel 8112. Meanwhile, the roller device 82 for controlling the relative lifting and turnover of blades is driven to rotate by the planetary gear carrier 8115 so as to drag the first secondary blade 2 and the second secondary blade 3 to lower in a preset direction and turn over all blades as a whole until the blades are closed. When the handle 8111 is shaken reversely, the sun gear 8113 is rotated counterclockwise. At this time, as the head 81311 of the second slider mechanism 813 is engaged with the ratchet 81122 of the locking ratchet wheel 8112, the locking ratchet wheel 8112 is hindered to rotate counterclockwise and thus locked. If the planetary gear carrier 8115 is unlocked, the planetary gear carrier may rotate clockwise and drive the power output locking gear 81110 and the overall lifting locking gear 8117 to rotate clockwise via the second transmission gear 8119 and the first transmission gear 8118 respectively (referring to FIG. 15). When the power output locking gear 81110 is rotated to a position where the notch 811101 is fitted with the head of the first slider 8121 of the first slider mechanism 812, the first slider 8121 slides downward under the action of the compression spring 8122 so as to engage with the notch 811101 on the power output locking gear 81110 and hinder the power output locking gear 81110 to rotate counterclockwise. On the other hand, the driving gear 8131 pushes the second slider 8131 of the second slider mechanism 813 to slide downward via the pin shaft 8116 after overcoming the acting force of the compression spring 8122 and then gradually separate from the ratchet 81122 of the locking ratchet wheel 8112. When the first slider 8121 is engaged with the notch 811101 on the power output locking gear 81110, the second slider 8131 is completely separated from the ratchet 81122 of the locking ratchet wheel 8112, and the lifting device 81 for controlling the overall lifting and switching of blades of the sequential control roller system 81 returns to the original state (FIG. 13).

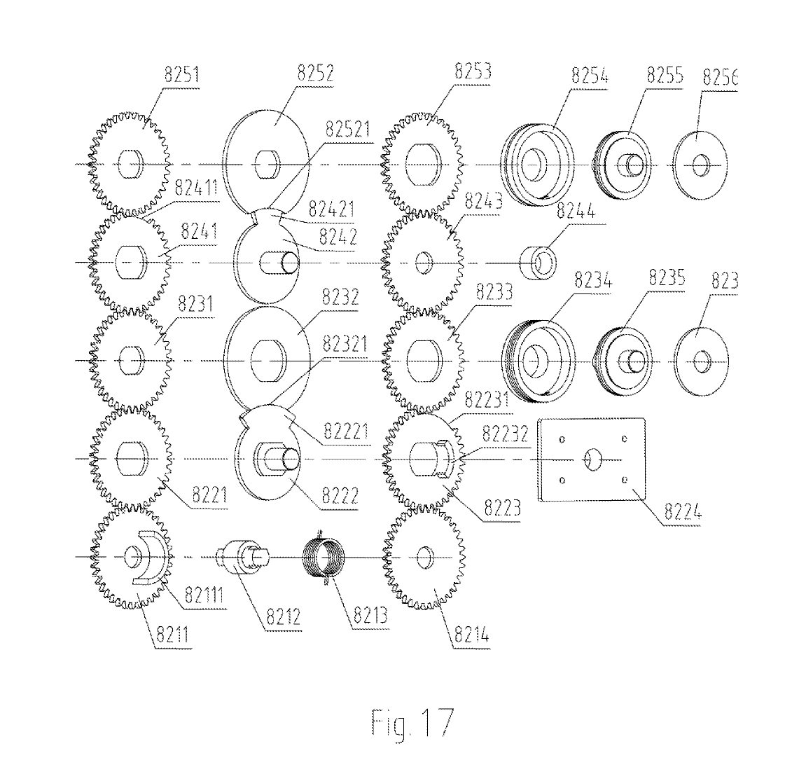

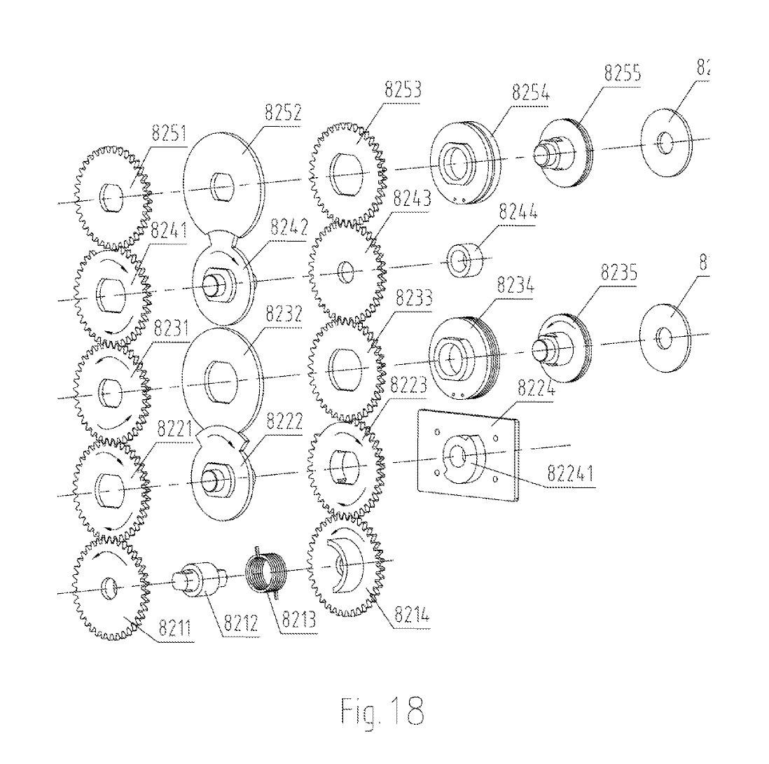

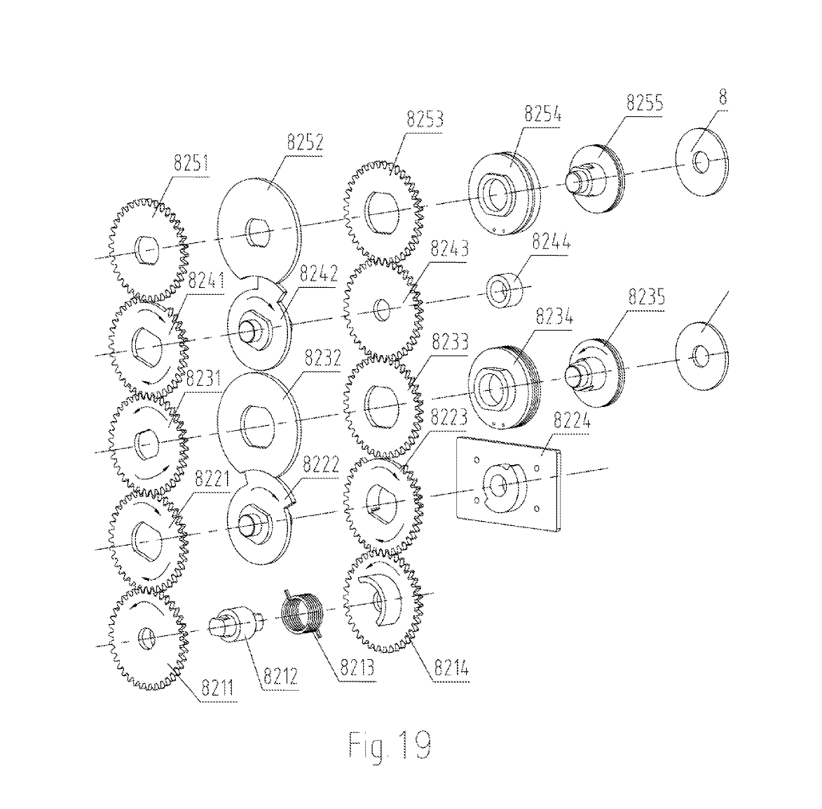

FIG. 7 is a three-dimensional diagram of the roller device 82 for controlling the relative lifting and turnover of blades of the sequential control roller system for a variable pitch shutter having built-in hollow glass. The roller device 82 consists of a torsion spring locking mechanism 821, a turnover drum locking mechanism 822, a first roller mechanism 823, a second roller locking mechanism 824 and a second roller mechanism 825. FIG. 17 is a right axonometric exploded view of the roller device 82 for controlling the relative lifting and turnover of blades of the sequential control roller system 8 for a variable pitch shutter having built-in hollow glass. FIG. 18 is a left axonometric exploded view of the roller device for controlling the relative lifting and turnover of blades of the sequential control roller system 8 for a variable pitch shutter having built-in hollow glass, where the roller device 82 consists of a torsion spring locking mechanism 821, a turnover drum locking mechanism 822, a first roller mechanism 823, a second roller locking mechanism 824 and a second roller mechanism 825. The torsion spring locking mechanism 821 consists of a power input gear 8211 with an arc wall 82111 provided on one side, a fixed shaft 8212, a torsion spring 8213 and a gear 8214 with an arc wall 82141 provided on one side opposing to the power input gear 8211, wherein the torsion spring 8213 is sheathed on the fixed shaft 8212, and one end of the fixed shaft 8212 is embedded onto the wall of the right side frame 14 after passing through the power input gear 8211 while the other end thereof is embedded onto the other wall of the right side frame 14 after passing through the gear 8214. Two ends of the torsion spring 8213 are disposed in spaces between two ends of the arc wall 82111 of the power input gear 8211 and the two ends of the arc wall 82141 of the gear 8214, so as to form the torsion spring locking mechanism 821. The torsion spring locking mechanism 821 locks the roller device 82, so that the roller device 82 will not be driven by the weight of the blades and the bottom rail. The first turnover drum locking mechanism 822 consists of a power input gear 8211, a first cam 8222, a turnover drum control gear 8223 and a fixed block 8224 with a limiting boss 82241. Bosses are provided on two side shafts of the first cam 8222, respectively. The first cam 8222 together with the turnover drums locks the cam driving gear 8221 via the bossed on the two side shafts, and the turnover drums control the engagement of the gear 8223 to form an integral whole. Then, the left side shaft of the first cam 8222 is inserted into the side wall of the right side frame 14, while the right side shaft thereof is inserted into a central hole of the fixed block 8224. The fixed block 8224 is fixed on the right side frame 14 via a screw. The first roller mechanism 823 consists of a first roller driving gear 8231, a second cam 8232, a turnover drum control gear 8223, a first turnover drum 8234 with a boss on its bottom and two annular grooves on its outer ring, a first roller 8235 with an annular groove on its outer ring, and a turnover drum cover 8236. A central boss of the first turnover drum 8234 is embedded into central holes of the turnover drum driving gear 8233 and the second cam 8232, so that the first turnover drum, the turnover drum driving gear and the second cam form an integral whole. The left side shaft of the first roller 8235 is disposed on a wall of the right side frame 14 after passing through the first turnover drum 824, the turnover drum driving gear 8233 and the second cam 8232, wherein the boss on the left side shaft of the first roller 8235 is embossed in a central hole of the first roller driving gear 8231, so that the first roller and the first roller driving gear form an integral whole. The right side shaft of the first roller 8235 is disposed on another wall of the right side frame 14 after passing through the cover. The turnover drum cover 8236 encloses the first roller inside the first turnover drum 8234. The second roller locking mechanism 824 consists of a third can driving gear 8241, a third cam 8242, a second turnover drum transmission gear 8243 and a limiting sleeve 8244. A left side shaft on the third cam 8242 is disposed on a wall of the right side frame 14 after passing through the third cam driving gear 8241. A boss on the left side shaft is embedded into a central hole of the third cam driving gear 8241 so as to form an integral whole. A right side shaft on the third cam 8242 is disposed on another wall of the right side frame 14 after passing through the second turnover drum transmission gear 8243 and the limiting sleeve 8244. The second roller mechanism 825 consists of a second roller driving gear 8251, a fourth cam 8252, a second turnover drum driving gear 8253, a second turnover drum 8254 with an annular groove on its outer ring, a second roller 8255 and a turnover drum cover 8236. A boss on the bottom of the second turnover drum 8254 is embedded into a central hole of the second turnover drum driving gear 8253, so that the second turnover drum and the second turnover drum driving gear form an integral whole. A left side shaft of the second roller 8255 is disposed on a wall of the right side frame 14 after passing through the second turnover drum 8254, the second turnover drum driving gear 8253, the fourth cam 8252 and the second roller driving gear 8251, wherein a boss on the left side shaft of the second roller 8255 is embedded into the central hole of the fourth cam 8252 and the central hole of the second roller driving gear 8251 so that the left side shaft of the second roller, the fourth cam and the second roller driving gear form an integral whole. A right side shaft of the first roller 8255 is disposed on another wall of the right side frame 14 after passing through the cover.

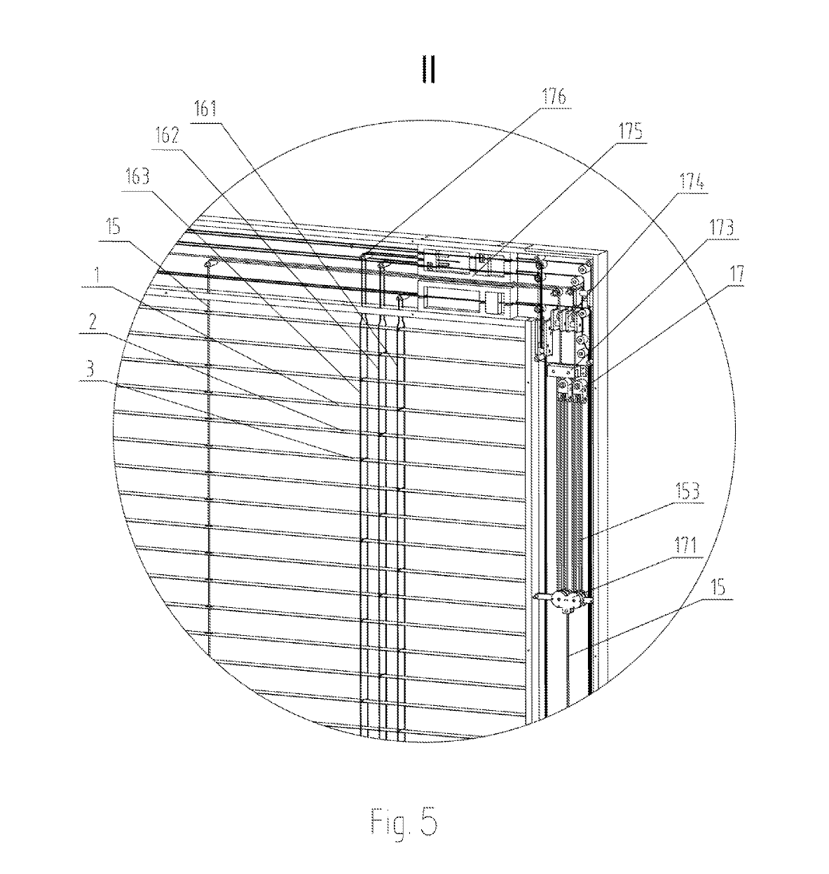

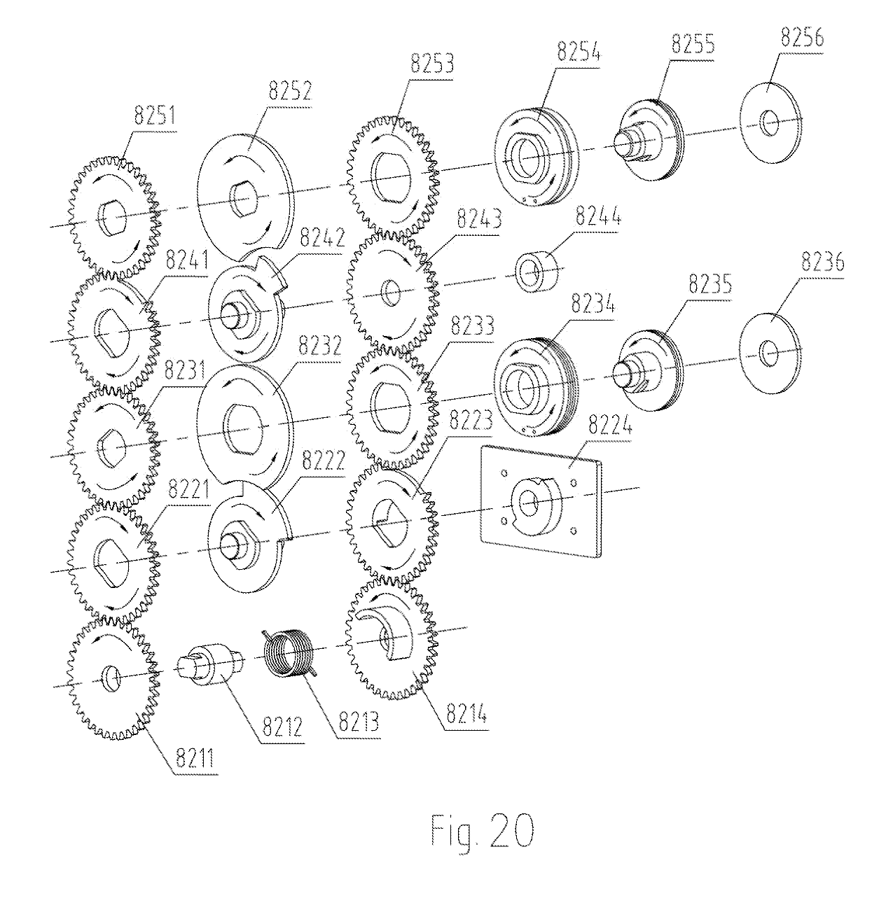

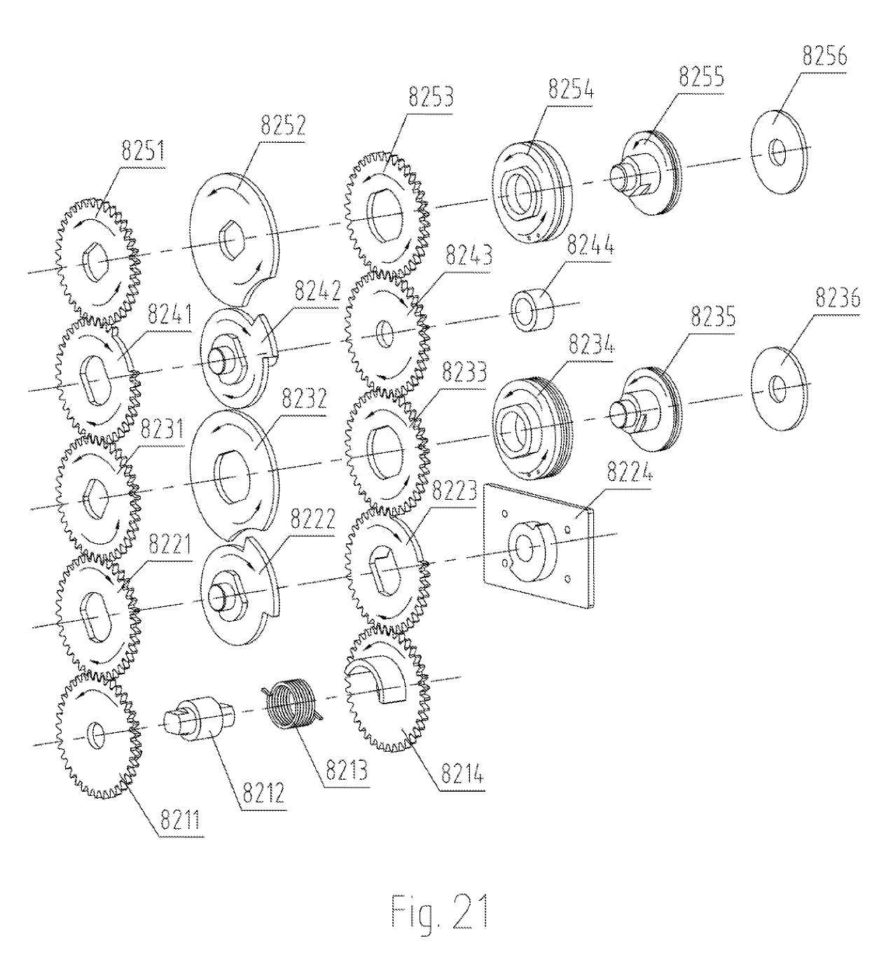

FIG. 5 is a three-dimensional diagram of connection relations between the lifting rope 15 and ladder belts 161, 162, 163 of the variable pitch shutter having built-in hollow glass and a steering device 17. The steering device 17 consists of a movable pulley 171, a fixed pulley 172, a guide block 173, a partition pin shaft 174, a partition block 175 and a pin shaft 176. A lower end is connected to the bottom rail 18 and passes through the end of the lifting rope 15 of the blades. The upper ends of the ladder belts 161, 162, 163 connected to the blades 1, 2, 3 pass through the top frame 11, are steered by the pin shaft 176 fixed in the top frame, then pass through the partition block 175 and enter the right side frame 14 after steered by the pin shaft. The lifting rope 15 is wound on the fixed pulley and the movable pulley. A flat rope is connected from the movable pulley 171, then extends downward and is wound the annular rope-winding groove 81126 of the locking ratchet wheel 8112 of the lifting device 81. The adder belts are connected to different rollers and turnover drums via the partition pin shaft 174, respectively. FIG. 16 is a three-dimensional diagram of the connection relation between ladder belts 161, 162, 163 and rollers and turnover drums. An upper end 1611 of the first ladder belt 161 is wound downward in the annular groove of the first turnover drum 8234 in the roller device 82 and connected to the bottom of the annular groove. The third ladder belt 163 is wound downward in the annular groove of the second turnover drum 8254 in the roller device 82, then passes through a hole on the bottom of the annular groove and is wound in the annular groove of the second roller 8255. A fixed point 1631 of the second ladder belt is fixed in the annular groove of the second roller 8255. Similarly, an upper end of the second ladder belt 162 is wound downward in the annular groove of the first turnover drum 8234 in the roller device 82, then passes through a hole on the bottom of the annular groove and is wound and fixed on the annular groove of the first roller 8235. After the overall descent process from the folding to unfolding of the blades of the variable pitch shutter, the positions of the blades are as shown in FIG. 3a. In this case, the left axonometric exploded view of the roller device 82 for controlling the relative lifting of first secondary blade 2 and second secondary blade 2 and the turnover of all blades corresponding to the state of blades as shown in FIG. 3a is as shown in FIG. 18. When the planetary gear carrier 8115 is rotated counterclockwise, the power input gear 8211 is also rotated in the same direction along with the planetary gear carrier and drives the gear 8214 to rotate in the same direction via the torsion spring 8213. The power input gear 8211 drives the first roller 8235, the second roller 8255, the first turnover drum 8234 and the second turnover drum 8254 to rotate via two groups of gears, respectively. The gear set for driving the rollers is the power input gear 8211, the first roller driving gear 8231, the third cam driving gear 8241 and the second roller driving gear 9251, and the gear set for driving the turnover drums is the mating gear 8214, the turnover drum control gear 8223, the turnover drum driving gear 8233, the second turnover drum transmission gear 8243 and the second turnover drum driving gear 8253. The sequential rotation of the rollers and the turnover drums is controlled by a cam set. The mechanism for controlling the rotation of the first turnover drum 8234 consists of the turnover drum locking can driving gear 8221, the first cam 8222, the second cam 8232, the turnover drum control gear 8223 and the turnover drum driving gear 8233. The mechanism for controlling the rotation of the second turnover drum 8254 consists of the mechanism for controlling the rotation of the first turnover drum 8234, the second turnover drum transmission gear 8243 and the second turnover drum driving gear 8253. The mechanism for controlling the second roller 8255 consists of the third cam driving gear 8241, the second roller driving gear 8251, the third cam 8242 and the fourth cam 8252. By counterclockwise rotating the power input gear 8211, the turnover drum locking cam driving gear 8221 is driven to rotate clockwise, the first roller driving gear 8231 is driven to rotate counterclockwise, and the third cam driving gear 8241 is driven to rotate counterclockwise. The first roller driving gear 8231 drives the first roller 8235 to rotate counterclockwise, and the third ladder belt 163 fixed on the first roller for controlling the second secondary blade 3 is loosened, so that the second secondary blade 3 translates downward under the action of its gravity. As the second roller driving gear 8251 and the third cam driving gear 8241 are not in an engagement state, the second roller 8255 is not rotated. As the turnover drum control gear 8223 and the turnover drum driving gear 8233 are not in an engagement state, the first turnover drum 8234 and the second turnover drum 8254 are not rotated. FIG. 19 is a left axonometric exploded view of the roller device 82 for controlling the relative lifting and turnover of blades when the second secondary blade 3 reaches a middle position of two groups of blades shown in FIG. 3b. In this case, the third cam driving gear 8241 beings to engage with the second roller driving gear 8251, and the turnover drum control gear 8223 begins to engage with the turnover driving gear 8233. When the power input gear 8211 continues to be rotated counterclockwise, the first roller driving gear 8231 drives the first roller 8235 integrated with the first roller to counterclockwise rotate along with it, and the third cam driving gear 8241 drives the second roller driving gear 8251 and the fourth cam 8252 and the second roller 8255 integrated with the second roller driving gear 9251 to counterclockwise rotate along with it. The second ladder belt connected to the second roller 8255 and used for controlling the first secondary blade 2 is loosened, so the first secondary blade 2 translates downward along with the second secondary blade 3 by virtue of its gravity. The turnover drum control gear 8223 is still not engaged with the turnover drum driving gear 8233 and thus in a static state, so that the first turnover drum 8234 and the second turnover drum 8254 are at the static state. When the first secondary blade 2 and the second secondary blade 3 reach to preset positions (referring to FIG. 3c), each mechanism part of the roller device 82 for controlling the relative lifting and turnover of blades corresponding to FIG. 3b is in the state shown in FIG. 20. In this case, the turnover drum control gear 8223 begins to engage with the turnover drum driving gear 8223, the third cam 8242 is out of contact with the fourth cam 8252, and the locking effects of the turnover drums are relieved. When the power input gear 8211 continues to be rotated counterclockwise, the mating gear 8214 is driven to rotate counterclockwise by the tension spring 8213, so that the turnover drum control gear 8223, the second turnover drum transmission gear 8243 and the second turnover drum driving gear 8253 of the second gear set engaged with the mating gear drive the second turnover drum 8254 to rotate counterclockwise by engagement transmission, and the turnover drum locking cam driving gear 8221, the first roller driving gear 8231, the third cam driving gear 8241 and the second roller driving gear 8251 of the first gear set drive the first roller 8235 and the second roller 8255 to continue to rotate counterclockwise, respectively, until the limiting arc wall of the turnover drum control gear 8223 reaches the limiting boss 82241 on the fixed block 8224. Thus, the blade separating/shutting and turnover device 82 stops rotating, and controls, together with the first ladder belt 161 connected to the first turnover drum for controlling the primary blade 1, and the second ladder 162 connected to the first roller 8235 and the third ladder belt 163 connected to the second roller 8255, the turnover of the primary blade 1, the second secondary 3 and the first secondary blade 2, respectively, until the variable pitch shutter is closed. In this case, the positions of the blades are as shown in FIG. 3d, and the state of each part of the blade separating/shutting and turnover device 82 is as shown in FIG. 21. After the variable pitch shutter is closed and if the handle 8111 is rotated counterclockwise, the blades of the variable pitch shutter are backtracked until the variable pitch shutter is folded as whole.

### Embodiment 2

The second ladder belt 162 and the first secondary blade 2 are omitted. That is, the roller system 8 may be applied in a variable pitch shutter formed from a plurality of blades, where there are two blades in each group. The remaining is the same as Embodiment 1.

What is claimed is:

1. A sequential control roller system for a variable pitch shutter, characterized in that the system comprises a lifting device (81) for controlling overall lifting and switchover of all blades and a blade separating/shutting and turnover device (82) for controlling the lifting of the blades relative to each other and the overall turnover of the blades, the lifting device (81) being in transmission connection to the blade separating/shutting and turnover device (82); the lifting device (81) comprises a planetary gear clutch capable of controlling the retraction and extension of a lifting rope (15) for realizing the overall fitting of all blades and capable of providing power to the blade separating/shutting and turnover device (82), and a switching slider mechanism for switching the working state of the planetary gear clutch; the blade separating/shutting and turnover device (82) comprises a number of blade turnover drums and blade translation control rollers; and, ladder belts for controlling the separate lifting and turnover of the blades are wound on the corresponding blade turnover drums and fixed on the corresponding blade translation control rollers.

2. The sequential control roller system for a variable pitch shutter according to claim 1, characterized in that the lifting device (81) further comprises a power output locking gear (81110) and an overall lifting locking gear (8117), which are in transmission connection to the planetary gear clutch via tooth engagement mechanisms, respectively, and the power output locking gear (81110) is in transmission connection to the blade separating/shutting and turnover device (82) via a tooth engagement mechanism.

3. The sequential control roller system for a variable pitch shutter according to claim 1, characterized in that the planetary gear clutch comprises a sun gear (8113), a set of planetary gears (8114), a lifting rope roller, a locking ratchet wheel (8112) and a planetary gear carrier (8115) with an external gear, the lifting rope roller, the locking ratchet wheel (8112) and the planetary gear carrier (8115) being coaxially parallel in turn and the lifting rope roller and the locking ratchet wheel (8112) being fixedly connected to each other, an annular groove (81126) for winding the lifting rope (15) being provided on the lifting rope roller, a ratchet (81122) being provided at the upper part of the locking ratchet wheel, inner teeth (81124) located on an end face facing the planetary gear carrier (8115) being also provided on the locking ratchet wheel (8112), the centers of the lifting rope roller, the locking ratchet wheel (8112) and the planetary gear carrier (8115) being all rotatably sheathed on a gear shaft of the sun gear (8113), the planetary gears (8114) being rotatably connected onto an end face of the planetary gear carrier (8115) opposing to the locking ratchet wheel (8112) and surrounding the sun gear (8113), the planetary gears (8114) being also engaged with the sun gear (8113) and the inner teeth (81124).

4. The sequential control roller system for a variable pitch shutter according to claim 3, characterized in that the switching slider mechanism comprises two guide seats (8123), two guide rods (8124), a first slider (8121) and a second slider (8131), the guide seats (8123) being fixed on a side frame of the hollow glass shutter, the two guide rods (8124) being fixedly connected onto the first slider (8121) and the second slider (8131), respectively, the guide seats (8123) being in sliding connection to the two guide rods (8124), respectively, compression springs (8122) being provided between the first slider (8121) and second slider (8131) and the corresponding guide seats (8123), a power output locking portion capable of coordinating with the first slider (8121) being provided on the power output locking gear (81110), an overall lifting locking portion capable of coordinating with the ratchet (81122) being provided on the second slider (8131), an axial boss being provided in the center of the power output locking gear (81110), the power output locking portion being a notch (811101) disposed on the boss and fitted with an end portion of first slider (8121), the overall lifting locking portion being a lateral step (81311).

5. The sequential control roller system for a variable pitch shutter according to claim 4, characterized in that a sectored groove is provided within the annular rope-winding groove (81126) of the lifting rope roller in the radial direction; on a sectored wall (81123) of the sectored groove, hinged is a Tr-shaped crank limiting rod (81125) capable of being turned-over to be hidden within the sectored groove and exposed from the sectored groove and capable of resisting against an end portion of the first slider (8121); and, a protruded driving pin shaft (8116) is provided between the center and edge of the overall lifting locking gear (8117), the driving pin shaft (8116) resisting against an end portion of the second slider (8131).

6. The sequential control roller system for a variable pitch shutter according to claim 1 characterized in that the blade separating/shutting and turnover device (82) comprises a torsion spring locking mechanism (821), a turnover drum locking mechanism (822), a first roller mechanism (823), a second roller locking mechanism (824) and a second roller mechanism (825), which are arranged from down to up in turn and in transmission connection to each other; each of the blade turnover drums comprises a first turnover drum (8234) disposed in the first roller mechanism (823) and a second turnover drum (8254) disposed in the second roller mechanism (825); each of the blade translation control rollers comprises a first roller (8235) disposed in the first roller mechanism (823) and a second roller (8255) disposed in the second roller mechanism (825); the torsion spring locking mechanism (821) comprises a power input gear (8211) and a mating gear (8214), which are coaxial to each other, with an arc wall (82111) and a complementary arc wall (82141) being provided on an end face of the power input gear (8211) opposing to the mating gear (8214), respectively; and, a torsion spring (8213) is sheathed on shafts of the power input gear (8211) and the mating gear (8214), and two ends of the torsion spring (8213) are disposed in clearances between corresponding ends of the arc wall (82111) and the complementary arc wall (82141), respectively.

7. The sequential control roller system for a variable pitch shutter according to claim 6, characterized in that the turnover drum locking mechanism (822) comprises a first cam driving gear (8221), a first cam (8222), a turnover drum control gear (8223) and a fixed block (8224) fixed on a side wall of the shutter, which are all coaxial to each other, the first cam driving gear (8221), the first cam (8222) and the turnover drum control gear (8223) being in transmission connection to each other, the first cam driving gear (8221) and the turnover drum control gear (8223) being engaged with the power input gear (8211) and the mating gear (8214), respectively; a raised arc section (82221) is provided on the first cam (8222); and, the turnover drum control gear (8223) is an incomplete gear with teeth provided on a part of the periphery and a smooth arc on the other part of the periphery, a limiting arc wall (82232) and a limiting boss (82241) which can be fitted with each other being provided on opposite faces of the turnover drum control gear (8223) and the fixed block (8224), respectively.

8. The sequential control roller system for a variable pitch shutter according to claim 7, characterized in that the first roller mechanism (823) comprises a roller driving gear (8231), a second cam (8232), a turnover drum driving gear (8233), a first turnover drum (8234) and a first roller (8235), which are all arranged coaxially in turn, the roller driving gear (8231) being engaged with the first cam driving gear (8221), the turnover drum driving gear (8233) being engaged with the turnover drum control gear (8223), the roller driving gear (8231) being in transmission connection to the first roller (8235), the second cam (8232) being in transmission connection to the first turnover drum (8234), an arc notch (82321) fitted with the raised arc section (82221) being provided on the second cam (8232), a first ladder belt (161) and a second ladder belt (162) being wound across the first turnover drum (8234), a fixed point of the first ladder belt (161) being fastened onto the first turnover drum (8234), the second ladder belt (162) being wound onto the first roller (8235) after going through the bottom of the first turnover drum (8234), a fixed point of the second ladder belt (162) being fastened onto the first roller (8235).

9. The sequential control roller system for a variable pitch shutter according to claim 8, characterized in that the second roller locking mechanism (824) comprises a third cam driving gear (8241), a third cam (8242) and a second turnover drum control gear (8243), which are all coaxially arranged in turn, the third cam driving gear (8241) being an incomplete gear with teeth provided on a part of the periphery and a smooth arc on the other part of the periphery, the third cam driving gear (8241) being engaged with the roller driving gear (8231) and being in transmission connection to the third cam (8242), a raised locking arc (82421) being provided on the third cam (8242), the second turnover drum control gear (8243) being engaged with the turnover drum driving gear (8233).

10. The sequential control roller system for a variable pitch shutter according to claim 9, characterized in that the second roller mechanism (825) comprises a second-stage roller driving gear (8251), a fourth cam (8252), a second turnover drum driving gear (8253), a second turnover drum (8254) and a second roller (8235), which are coaxially arranged in turn, the second-stage roller driving gear (8251) being engaged with the third cam driving gear (8241), the second turnover drum driving gear (8253) being engaged with the second turnover drum control gear (8243), the second-stage roller driving gear (8251), the fourth cam (8252) and the second roller (8255) being in transmission connection to each other, the second turnover drum driving gear (8253) being in transmission connection to the second turnover drum (8254), a locking notch (82521) fitted with the raised locking arc (82421) being provided on the fourth cam (8252), a third ladder belt (163) being wound across the second turnover drum (8254), the third ladder belt (163) being wound onto the second roller (8255) after going through the bottom of the second turnover drum (8253), a fixed point of the third ladder belt (163) being fastened onto the second roller (8255).
